(19) United States
(12) Patent Application Publication
(10) Pub. No.: US 2016/0106066 A1
(43) Pub. Date: Apr. 21, 2016

(54) Protective Footwear for Canines

(71) Applicant: Richard Arthur Montgomery, San Pedro, CA (US)

(72) Inventor: Richard Arthur Montgomery, San Pedro, CA (US)

(21) Appl. No.: 14/515,194

(22) Filed: Oct. 15, 2014

(51) Int. Cl. A01K 13/00

(52) U.S. Cl. CPC A01K 13/007

(57) ABSTRACT

A protective canine footwear is formed from an upper layer and a lower layer that form a pouch for the insertion of a dog's foot. An upper tab extends from the upper layer and has a hook and loop fastener material coupled thereto. A hook and loop strap coupled to the lower layer is configured to wrap around an upper portion of a dog's foot or leg to attach the protective canine footwear to a dog's foot. In one embodiment, the upper layer has a separation that extends from the opening toward the closed end. Either side of the separation is configured with hook and loop fastener material to close the separation. A non-slip material may be configured on the outside or bottom portion of the lower layer.

### REFERENCES CITED

U.S. Pat. No. 102,003,435 Jun. 4, 1935 Groff
U.S. Pat. No. 102,163,361 Jun. 20, 1939 Ford
U.S. Pat. No. 102,443,831 Jun. 22, 1948 Miller
U.S. Pat. No. 103,150,641 Sep. 29, 1964 Kesh
U.S. Pat. No. 103,209,726 Oct. 4, 1965 Fisher
U.S. Pat. No. 103,742,679 Jul. 3, 1973 Jordan
U.S. Pat. No. 105,148,657 Sep. 22, 1992 Stafford
U.S. Pat. No. 105,452,685 Sep. 26, 1995 Thomas
U.S. Pat. No. 105,528,885 Jun. 25, 1996 Chamberlain
U.S. Pat. No. 105,676,095 Oct. 14, 1997 Ralls
U.S. Pat. No. 106,526,920 Mar. 4, 2003 Griffin
U.S. Pat. No. 106,546,704 Apr. 15, 2003 Fisher
U.S. Pat. No. 4,744,333 Jul. 2, 1984 Taylor
U.S. Pat. No. 2,064,566 Dec. 15, 1936 Richman
U.S. Pat. No. 5,495,828 Mar. 5, 1996 Solomon
U.S. Pat. No. 5,408,812 Apr. 25, 1995 Stark
U.S. Pat. No. 8,794,191 Aug. 5, 2014 Friedland
U.S. Pat. No. 2,651,853 Sep. 15, 1953 Lewis
U.S. Pat. No. 2,424,172 Jul. 15, 1947 Huddleston
U.S. Pat. No. 2,535,394 Dec. 26, 1950 Davis
U.S. Pat. No. 2,651,853 Sep. 15, 1953 Lewis
U.S. Pat. No. 2,826,172 Mar. 11, 1958 Buckle
U.S. Pat. No. 3,067,532 Dec. 11, 1962 Peterson
U.S. Pat. No. 3,747,565 Jul. 24,1973 Kellam
U.S. Pat. No. 4,597,359 Jul. 1, 1986 Moorman
U.S. Pat. No. 4,633,817 Jan. 6, 1987 Taylor
U.S. Pat. No. 6,131,251 Oct. 17, 2000 Provost

### BACKGROUND OF THE INVENTION

1. Field of the Invention

The present invention relates to protective footwear for canines.

2. Background

Dog's feet are exposed to a wide variety and sometimes unfriendly surfaces. The pavement can become excessively hot and broken glass is a routine hazard. In addition, thorns may become stuck in a dog's paw and insects, such a fire ants may bite a dog's paw. Dogs have a carpal pad that is located up from a dog's feet. In addition, many dogs have a dewclaw that is most often located up and to the side of the dog's foot.

There exists a need for protective footwear for canines that can be easily applied and adjusted for the variation in dog anatomy, including carpals and dewclaws.

### SUMMARY OF THE INVENTION

The invention is directed to protective footwear for canines. In an exemplary embodiment, a protective canine footwear comprises an upper layer and a lower layer forming a pouch having an opening and a closed end. The upper layer and lower layer may be attached by a seam on either side to form the pouch. In another embodiment, the upper and lower layers are attached by a seam on one side only, thereby allowing a single piece of material to be folded over and sealed to form the pouch. The upper and lower layers may be attached along the closed end to form the pouch. Any suitable seam may be used including, but not limited to, a sewn seam, a stitched seam a weld seam, an ultrasonic weld seam, an adhesive seam and the like.

In an exemplary embodiment, a protective footwear for canines comprises an upper tab extending from the upper layer and has a hook and loop fastener material coupled thereto. A hook and loop strap coupled to the lower layer Docket No.: ITP/151 may be configured to wrap around a dog's leg or upper foot to detachably attach to the hook and loop material coupled to the upper tab. The extended tabs allows for securing attaching the protective canine footwear to dogs of a wide range of sizes and anatomies. It is to be understood that the hook and loop strap may be configured on the upper tab and a hook and loop material may be configured on a lower tab, or an opposite configuration as shown and described herein.

An exemplary protective canine footwear comprises a body portion that comprises an upper layer and a bottom layer each having a soft compliant material configured on the outside and a smooth/low friction material configured on the inside, or lining the pouch. The soft compliant material may be configured to provide comfort for the dog walking on a wide variety of surfaces and the smooth/low friction inner layer may be configured to allow the footwear to easily slide over a dog's foot.

A protective canine footwear may further comprise a reflective strip configured an outside portion of the upper layer. A reflective strip may be provided for safety as it will aid in a person spotting a dog. A reflective strip may comprise material that is configured to glow very brightly at night when a light, such as the headlight of a car shines on it. In another embodiment, a glow in the dark material may be configured on a portion of a protective canine footwear.

A protective canine footwear may further comprise a non-slip material configured on the bottom of the lower layer and configured for contact with a walking surface.

An exemplary protective canine footwear comprises a separation in the upper layer that extends from the opening toward the closed end to create a first side and a second side of the separation. Hook and loop fasteners may be configured on either side of the separation to enable detachable attachment of the first side to the second side. This embodiment enables a user to open the pouch by separating the first side from the second side and placing a dog's foot into the pouch through the separation or top of the body portion.

The summary of the invention is provided as a general introduction to some of the embodiments of the invention, and is not intended to be limiting. Additional example embodiments including variations and alternative configurations of the invention are provided herein. Docket No.: ITP/151

### BRIEF DESCRIPTION OF THE DRAWINGS

The accompanying drawings are included to provide a further understanding of the invention and are incorporated in and constitute a part of this specification, illustrate embodiments of the invention, and together with the description serve to explain the principles of the invention.

### DETAILED DESCRIPTION OF THE ILLUSTRATED EMBODIMENTS

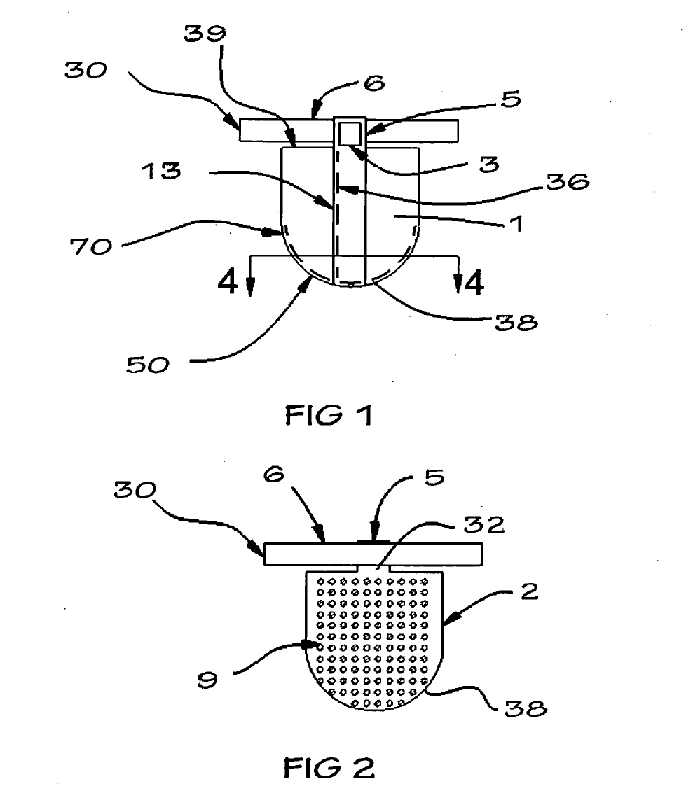

FIG. 1 shows a top view of an exemplary protective canine footwear having a top tab and a hook and loop strap.

FIG. 2 shows a bottom view of an exemplary protective canine footwear having a hook and loop strap and a non-slip material on the bottom surface.

FIG. 3 shows a perspective view of an exemplary protective canine footwear having an opening for the insertion of a dog's foot, a reflective safety strip along the upper layer and a hook and loop strap extending from the bottom layer of the footwear.

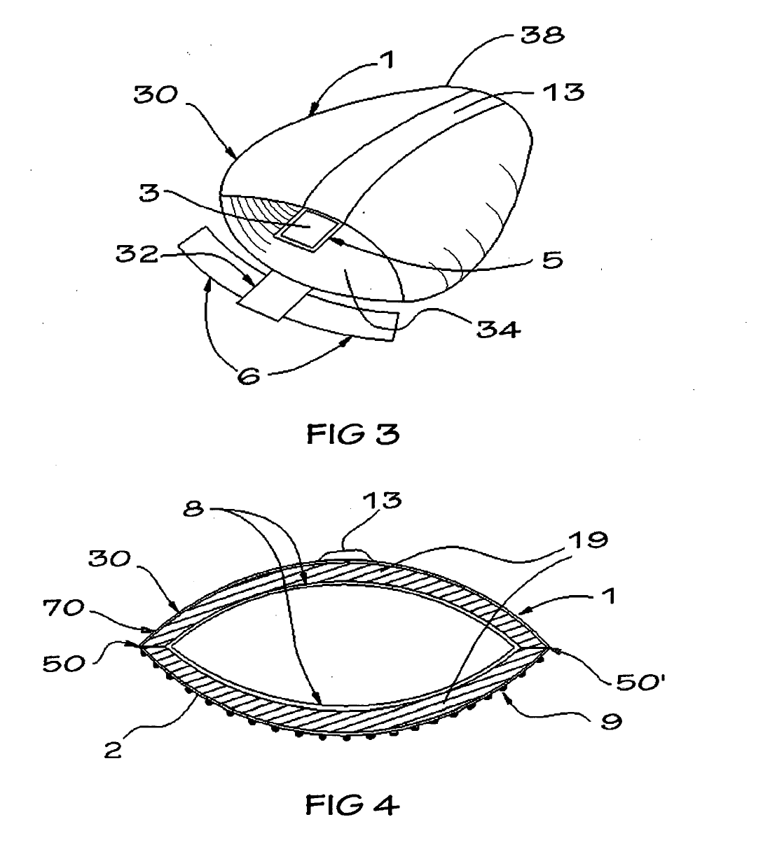

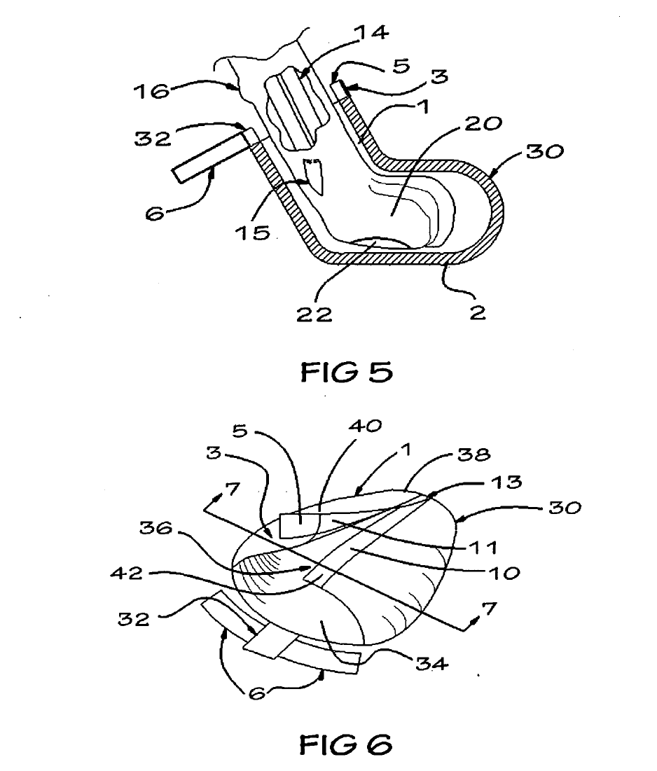

FIG. 4 shows a cross-sectional view of the exemplary protective canine footwear along line 4 in FIG. 1. The upper layer and lower layer form a pouch for receiving a dog's foot or paw.

FIG. 5 shows a side cross-sectional view of an exemplary protective canine footwear configured over a dog's foot.

FIG. 6 shows a perspective view of an exemplary protective canine footwear having a separation in the top layer for insertion of a dogs foot.

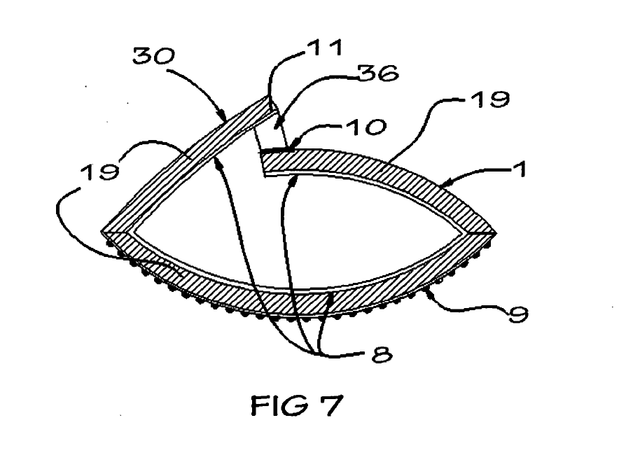

FIG. 7 shows a cross-sectional view of the exemplary protective canine footwear along line 7 in FIG. 6. The upper layer is separated and configured for attachment by a hook and loop fastener.

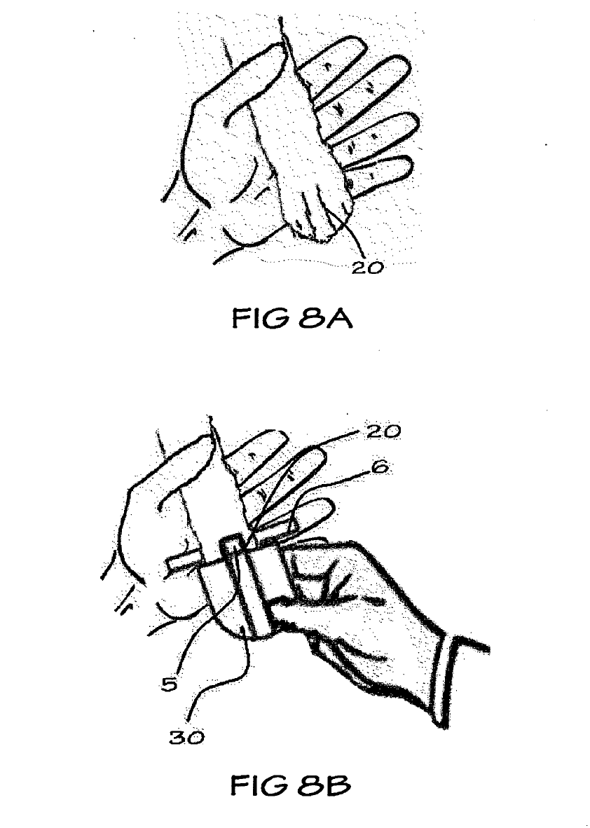

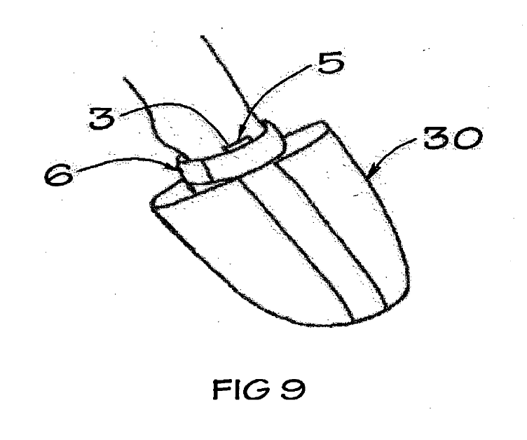

FIG. 8A shows dog's paw in a person's hand.

FIG. 8B show a person placing an exemplary protective canine footwear over the dog's foot.

FIG. 9 shows an exemplary protective canine footwear configured over a dog's paw with the hook and loop strap configured around the dog's leg.

Corresponding reference characters indicate corresponding parts throughout the several views of the figures. The figures represent an illustration Docket No.: ITP/151 of some of the embodiments of the present invention and are not to be construed as limiting the scope of the invention in any manner. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Certain exemplary embodiments of the present invention are described herein and are illustrated in the accompanying figures. The embodiments described are only for purposes of illustrating the present invention and should not be interpreted as limiting the scope of the invention. Other embodiments of the invention, and certain modifications, combinations and improvements of the described embodiments, will occur to those skilled in the art and all such alternate embodiments, combinations, modifications, improvements are within the scope of the present invention.

As shown in FIG. 1, an exemplary protective canine footwear 30 has a tab 5 that extends from the upper layer 1 and comprises a hook and loop fastener material 3 configured to attach and retain a portion of the hook and loop strap 6. A reflective strip 13 is configured along the upper layer of the exemplary protective canine footwear 30. The reflective strip may enable a motorist to more easily spot a dog that might be running into the street. In addition, a dog owner may more easily keep track or find a dog when they are wearing protective canine footwear having reflective strips as shown in FIG. 1. The body portion 70 of the protective canine Docket No.: ITP/151 footwear 30 has an open end 39 and an closed end 38. The body portion 70 has a seam 50 that extends along the closed end 38. A seam may be a stitch.

As shown in FIG. 2, an exemplary protective canine footwear 30 has a hook and loop strap 6, and a non-slip material 9 on the bottom surface of the footwear. The hook and loop strap 6 is coupled with a tab lower 32 that extends from the lower layer 2 of the protective canine footwear 30.

As shown in FIG. 3, an exemplary protective canine footwear 30 has an opening 34 configured for the insertion of a dog's foot. The upper layer 1 and bottom layer form a pouch having a closed end and an open end. A reflective safety strip 13 extends along the upper layer 1. A hook and loop strap 6 extends from lower tab 32, and the lower tab extends from lower layer of the footwear. The upper tab 5 is configured with a hook and loop material 3 and the strap 6 is configured to extend around a dog's leg and attach to the hook and loop material 3 on the upper tab 5.

As shown in FIG. 4, an exemplary protective canine footwear comprises am upper layer 1 and lower layer 2 that form a pouch for receiving a dog's foot or paw. The exemplary protective canine footwear 30 comprises a soft compliant material 19 and a smooth/low friction inner layer 8. The non-slip layer 9 is shown as comprising a plurality of raised elements from the bottom of the exemplary protective canine footwear. The reflective strip 13 is configured on the top of the exemplary protective canine footwear. The body portion 70 of the protective canine footwear 30 comprises seams 50, 50′ along the opposing sides or between the upper layer and lower layers.

As shown in FIG. 5, an exemplary protective canine footwear 30 is configured over a dog's foot 20. The dog's foot is configured within the exemplary protective canine footwear with the dog's pads 22 facing down or toward the lower layer 2. The dog's dewclaw 15 is configured within the opening of the exemplary protective canine footwear. The dog's carpal pad 16 is configured outside of the exemplary protective canine footwear. The hook and loop strap 6 is extending from the lower tab 32 and is configured to extend around the dog's foot or leg and attach to the upper tab 5.

As shown in FIG. 6, an exemplary protective canine footwear 30 has a separation 36 in the top layer 1 for insertion of a dogs foot. The separation is a Docket No.: ITP/151 slit that extends from the opening 34 toward the closed end 38 of the exemplary protective canine footwear 30 and creates a first side 40 and a second side of the separation 42. Hook and loop fasteners 10 and 11 are configured along the separation, or on the first and second sides respectively, for attachment and closure of the separation. Hook and loop fastener 10 may be the loop portion and the hook portion may be 11, or vice-versa.

As shown in FIG. 7, an exemplary protective canine footwear 30 comprises a separation 36 in the upper layer 1. The soft and compliant material 19 is shown being configured outside of the smooth/low friction material 8. The smooth/low friction material 8 is configured as an inner layer within the pouch formed by the upper and lower layers.

As shown in FIG. 8A, a dog's foot in a person's hand.

As shown in FIG. 8B, a person is placing an exemplary protective canine footwear 30 over the dog's foot. The hook and loop strap 6 is configured on the back side of the dog's foot and the upper tab 5 is configured on the front portion of the dog's foot.

As shown in FIG. 9, an exemplary protective canine footwear 30 is configured over a dog's foot with the hook and loop strap 6 configured around the dog's leg and attached to the hook and loop fastener material 3 on the upper tab 5.

It will be apparent to those skilled in the art that various modifications, combinations and variations can be made in the present invention without departing from the spirit or scope of the invention. Specific embodiments, features and elements described herein may be modified, and/or combined in any suitable manner. Thus, it is intended that the present invention cover the modifications, combinations and variations of this invention provided they come within the scope of the appended claims and their equivalents.

It would be obvious to anyone skilled in the art that the features of the present invention coupled can be extended beyond footwear for dogs to include footwear for other animals or even humans.

1. A protective canine footwear comprising:
a body portion consisting of:
a single upper layer; and
a single lower layer;
wherein the upper layer and the lower layer are attached to each other by a seam to form a pouch having an opening and a closed end;
wherein the seam extends from a first side of the opening around the closed end to a second and opposing side of said opening from said first side;
a slit in the upper layer and extending from the opening to the closed end forming a first and second side of the upper layer;
a hook and loop fastener extending along either side of said slit for detachably attaching the first and second side of the upper layer together to form said pouch;
an upper tab extending from said opening, from the first side of the upper layer at the slit and having a hook and loop fastener material coupled thereto; and
a hook and loop strap coupled to a lower tab that extends from the lower layer at the opening;
wherein the hook and loop strap extends from said lower tab in opposing directions around the opening;
whereby the hook and loop strap is configured to extend around a dog's foot and attach with the hook and loop material coupled to the upper tab, thereby retaining the protective canine footwear to said dog's foot
wherein the protective canine footwear comprises no laces for coupling the first and second side of the upper layer together.

2. (canceled)

3. The protective canine footwear of claim 1, wherein the upper layer comprises:
a soft compliant material; and
a smooth, low friction inner layer;
wherein the smooth, low friction inner layer is configured inside of the soft compliant material.

4. The protective canine footwear of claim wherein the lover layer comprises:
soft compliant material; and
a smooth, low friction inner layer;
wherein the smooth, low friction inner layer is configured inside of the soft compliant material.

5. The protective canine footwear of claim 1, further comprising a reflective strip configured on an outside portion of the upper layer.

6. The protective canine footwear of claim 5, wherein the reflective strip extends along a portion of a length of the slit in the upper layer.

7. The protective canine footwear of claim 6, wherein the hook and loop fastener extending along either side of the slit extends substantially the entire length of the It from the closed end to the opening.

8. The protective canine footwear of claim 1, further comprising non-slip material configured on an outside bottom portion of the lower layer.

9. A protective canine footwear comprising:
a body portion consisting of:
a single upper layer; and
a single lower layer;
wherein the upper layer and the lower layer are attached to each other by a seam to form a pouch having an opening and a closed end;
wherein the seam extends from a first side of the opening around the closed end to a second and opposing side of said opening from said first side;
a slit in the upper layer and extending from the opening to the closed end forming a first and second side of the upper layer;
a hook and loop fastener extending along either side of said slit for detachably attaching the first and second side of the upper layer together to form said pouch;
wherein both the upper and lower layer comprise:
a soft compliant material; and
a smooth, low friction inner layer;
wherein the smooth, low friction inner layer is configured inside of the soft compliant material;
an upper tab extending from said opening, from the first side of the upper layer at the slit and having a hook and loop fastener material coupled thereto;
a lower tab that extends from the lower layer from the opening; and
a hook and loop strap coupled to the lower tab;
wherein the hook and loop strap extends from said lower tab in opposing directions around the opening;
whereby the hook and loop strap is configured to extend around a dog's foot and attach with the hook and loop material coupled to the upper tab, thereby retaining the protective canine footwear to said dog's foot; and
a reflective strip configured an outside portion of the upper layer,
wherein the protective canine footwear comprises no laces for coupling the first and second side of the upper layer together.

10. The protective canine footwear of claim 9, wherein the hook and loop fastener extending along either side of the slit extends substantially the entire length of the slit from the closed end to the opening.

11. The protective canine footwear of claim 10, wherein the reflective strip extends along the slit in the upper layer.

12. The protective canine footwear of claim 9, further comprising non-slip material configured on an outside bottom portion of the lower layer.
